(19) United States
(12) Patent Application Publication
(10) Pub. No.: US 2009/0213281 A1
(43) Pub. Date: Aug. 27, 2009

(54) SYSTEM AND METHOD FOR IMPROVED CONTRAST RATIO IN A PROJECTION SYSTEM

(76) Inventor: Garrett J. Young, Sully, IA (US)

Correspondence Address: SCHWEGMAN, LUNDBERG & WOESSNER, P.A., P.O. BOX 2938, MINNEAPOLIS, MN, 55402, US

(21) Appl. No.: 12/389,768

(22) Filed: Feb. 20, 2009

Related U.S. Application Data
(60) Provisional application No. 61/031,524, filed on Feb. 26, 2008.

(51) Int. Cl. G02F 1/133

(52) U.S. Cl. 349/5

(57) ABSTRACT

A system embodiment comprises an analyzer, a Liquid Crystal Display (LCD), and a compensation plate. The LCD allows, limits or blocks passage of polarized light as a projected image to the analyzer. The LCD includes a plurality of crystals that provide the LCD with a plurality of pixels, and the crystals in the LCD have non-ideal polarization states resulting from receipt and retardance of non-collimated incident angles of light. The non-ideal polarization states introduce unwanted phase shifts of the light in the projected image. The compensation plate is configured to introduce desired phase shifts to compensate for the unwanted phase shifts of the light introduced by non-ideal polarization states introduced by the LCD.

This application claims the benefit under 35 U.S.C. 119(e) U.S. Provisional Patent Application Ser. No. 61/031,524, filed on Feb. 26, 2008, which is incorporated herein by reference in its entirety.

### TECHNICAL FIELD

This application relates generally to video and image projection/display systems and liquid crystal technology, such as those utilizing transmissive Liquid Crystal Display (LCD) technology.

### BACKGROUND

LCD panels (such as those used in video projection systems) allow, limit, or block passage of polarized light when used in conjunction with an analyzer (i.e. a clean-up polarizer) and pre-polarizer. More specifically, these LCD panels are comprised of individual pixels, where each pixel can allow the light to pass through in its initial polarized state (which will be blocked by the analyzer), cause the light to phase shift 90 degrees (which will then be passed through by the analyzer), or some degree of phase shift variation of the two (which will allow some of the light to pass through the analyzer). (For purposes of explanation herein, a pixel that is set to allow light to pass through in its initial polarized state will be designated as “off,” while one set to shift light 90 degrees will be designated “on.”)

When light is passed through these LCD panels, manipulation of the individual pixels can produce a desired image. To make for a sharper image and enhance the “contrast,” those pixels that have been set to a particular state (e.g., “on” or “off”) should appear distinct from those nearby or adjacent pixels that have been set to a different state level. If the difference in brightness amongst such pixels is less distinct, then individual objects displayed in the image may appear less distinct, which is often an undesirable result.

As indicated above, typically, LCD panels require the use of polarized light to function properly. In a projector, the pixels in an LCD will be manipulated very quickly to give the viewer the appearance of motion. An example of an LCD panel is the Seiko-Epson Twisted Nematic, (TN90) xLCD 1.3 inch Micro-Display Panel (“TN90”) transmissive LCD panel from Seiko Epson Corp. of Japan. Typically, in a color projector, there will be an LCD for each of the primary colors being used (e.g., red, green, and blue).

### SUMMARY

Aberrations in systems that use polarized light for LCD projection systems can be caused by light striking an LCD panel at varying degrees of incidence. Specifically, the crystals making up the pixels of an LCD may cause unwanted retardance of light received at an angle, especially a large angle, thus introducing light components that have an unwanted effect on the analyzer (i.e., unintended light may pass through or be blocked by the analyzer), thus having an adverse effect on the contrast of the image.

A system embodiment comprises an analyzer, a Liquid Crystal Display (LCD), and a compensation plate. The LCD allows, limits or blocks passage of polarized light as a projected image to the analyzer. The LCD includes a plurality of crystals that provide the LCD with a plurality of pixels, and the crystals in the LCD have non-ideal polarization states resulting from receipt and retardance of non-collimated incident angles of light. The non-ideal polarization states introduce unwanted phase shifts of the light in the projected image. The compensation plate is configured to introduce desired phase shifts to compensate for the unwanted phase shifts of the light introduced by non-ideal polarization states introduced by the LCD.

A method embodiment comprises setting all pixels in a liquid crystal display (LCD) “on”, measuring light transmission when all pixels are set “on”, setting all pixels in LCD “off”, and measuring light transmission when all pixels are set “off”. If the measured light transmissions are not acceptable, a compound angle of a compensation plate is adjusted with respect to the LCD, and light transmission is re-measured when all pixels are set “on” and when all pixels are set “off”.

A method embodiment comprises turning a liquid crystal display (LCD) “full on” to be transmissive, directing light through the full on LCD at a plurality of angles, determining retardance for the LCD for the plurality of angles, constructing a polar plot to represent the retardance for the plurality of angles, and using the polar plot to provide an appropriate coating for a compensate plate to compensate for the retardance of the LCD.

This Summary is an overview of some of the teachings of the present application and not intended to be an exclusive or exhaustive treatment of the present subject matter. Further details about the present subject matter are found in the detailed description and appended claims. Other aspects will be apparent to persons skilled in the art upon reading and understanding the following detailed description and viewing the drawings that form a part thereof, each of which are not to be taken in a limiting sense. The scope of the present invention is defined by the appended claims and their equivalents.

### BRIEF DESCRIPTION OF THE DRAWINGS

FIG. 1 is a diagram depicting a first example embodiment of the present subject matter.

FIG. 2 is a diagram depicting a second example embodiment of the present subject matter.

FIGS. 3A and 3B depict an example orientation of the compensation plate 114 with respect to LCD 110.

FIG. 4 depicts the relative orientations of various components as used in one or more embodiments of the present subject matter.

FIG. 5 depicts aspects of the compensation plate 114 as envisioned by one or more embodiments of the present subject matter.

FIG. 6 discloses various components as envisioned by one or more embodiments of the present subject matter.

FIG. 7 depicts a mechanism for holding together and manipulating the various plates and related components for assembly as envisioned by one ore more embodiments of the present subject matter.

### DETAILED DESCRIPTION

The following detailed description of the present subject matter refers to the accompanying drawings which show, by way of illustration, specific aspects and embodiments in which the present subject matter may be practiced. These embodiments are described in sufficient detail to enable those skilled in the art to practice the present subject matter. Other embodiments may be utilized and structural, logical, and electrical changes may be made without departing from the scope of the present subject matter. References to “an”, “one”, or “various” embodiments in this disclosure are not necessarily to the same embodiment, and such references contemplate more than one embodiment. The following detailed description is, therefore, not to be taken in a limiting sense, and the scope is defined only by the appended claims, along with the full scope of legal equivalents to which such claims are entitled.

The present subject matter significantly enhances the contrast in a displayed or projected image utilizing liquid crystal technologies (e.g., LCD panels for projection systems), allowing a viewer to experience a greater range of light intensities. To enhance the contrast of such a displayed or projected image, generally, individual pixels in the liquid crystal technology effectively should allow light to be transmitted without phase shift when set to “off,” and shift the phase of the light 90 degrees when set to “on.” Thus, the pixels should not introduce unwanted phase shifts of the light that passes through them.

Systems and methods for reducing this light leakage and enhancing contrast in accordance with embodiments of the present subject matter will be discussed below. In particular, a special type of wave retarder (referred to as a compensation plate, below) is used that is angled (clocked) and rotated with respect to the orientation of the LCD panel. More specifically, the compensation plate pre-compensates for phase shifting caused by retardance of the LCD when light is passed through the LCD at various angles, thus enhancing contrast. In other words, the compensation plate cancels or “undoes” the effect that the LCD panel has on the polarized light when it is received by the LCD at various angles. The end result helps, e.g, inhibit pixels that have been set to limit or block incident light from, in effect, bleeding additional light into the projected image. (Although discussed primarily with regard to LCD panels, it should be understood that various embodiments of the present subject matter contemplate use with other types of liquid crystal technologies, as well.)

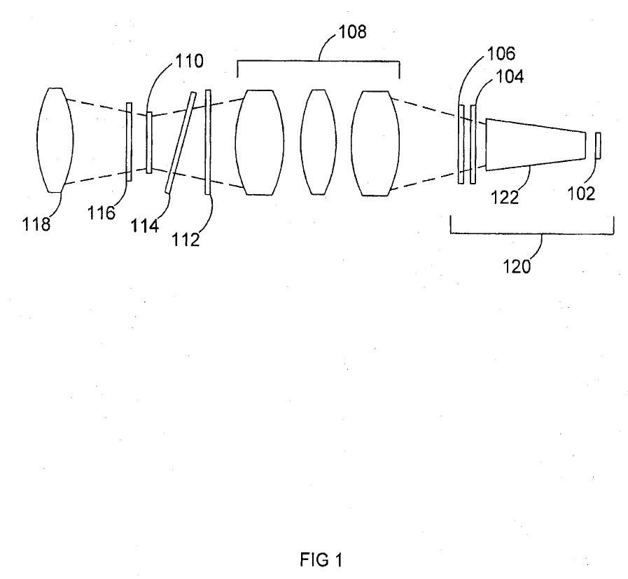

Various embodiments are now discussed with regard to FIG. 1. Referring to FIG. 1, in one or more embodiments, a light source 102 (e.g., a solid state light source having one or more light emitting diodes) transmits light to a ¼ wave retarder 104 and reflective polarizer 106 to produce linear polarized light. A more detailed discussion of such systems and methods for creating recycled polarized light can be found in U.S. application Ser. No. 11/941,707 (US 2008/0231953A1) entitled SYSTEM AND METHOD FOR LED POLARIZATION RECYCLING, filed Nov. 16, 2007, which is incorporated by reference herein in its entirety. Of course, it should be understood that various embodiments contemplate that any number of systems and techniques can be used to obtain the initial linearly polarized light. (As should be understood from the discussion further below, a pre-polarizer can be used to provide the polarized light for the LCD, as can a light polarizing system 120. However, a combination of the two can provide a higher purity polarization of light, resulting in improved throughput and contrast.)

Once the light is linearly polarized, it is directed to a relay optics assembly 108, which in one or more embodiments is a one-to-one relay system. This assists to ultimately transfer more of the light from the light source 102 to a liquid crystal display 110, conserving system etendue.

Upon passing through the relay optic assembly 108, in one or more embodiments, the light generally will be received by a pre-polarizer 112, then by a compensation plate 114, then by an LCD 110, then by an analyzer 116, and then by a projection assembly 118 which may be one or more lenses. In one or more embodiments, the pre-polarizer 112 and the analyzer 116 are ultra-high contrast Moxtek wire grid polarizers from Moxtek, Inc. of Orem, Utah. (Wire-grid polarizers provide essentially the same level of polarization whether the light comes in at 0° or at a very high angle.)

As mentioned above, the compensation plate 114 is used to compensate for the unwanted phase shifting (and ultimate “leakage”) of light due to the angles at which the polarized light comes in contact with the LCD 110, as mentioned above. As indicated previously, the compensation plate 114 compensates for non-ideal polarization states resulting from receipt (and retardance) by the LCD of non-collimated incident angles of light generated by the light polarizing system 120. Such compensation serves to enhance contrast in the image that is ultimately projected by the system.

In one or more embodiments, the compensation plate 114 has an organiz coating that gives it its retardance capabilities. An example of a compensation plate 114 that can be used with, e.g., the Epson TN90 LCD panel mentioned above is compensation plate part #30119372 from JDSU of Milpitas, Calif.

To better optimize the compensating effect of the compensation plate 114 (and thus enhance contrast), various embodiments envision that the compensation plate 114 is positioned at a compound angle relative to the position of LCD 110. This will be described in greater detail below. In general, in one or more embodiments, the compensation plate 114 is inserted between the pre-polarizer 112 and the LCD 110 at a certain compound “tilted” angle and then clocked in-plane. Also, in one or more embodiments, the temperature of the compensation plate 114 and other components is envisioned to be taken into consideration (e.g., maintained at a certain temperature).

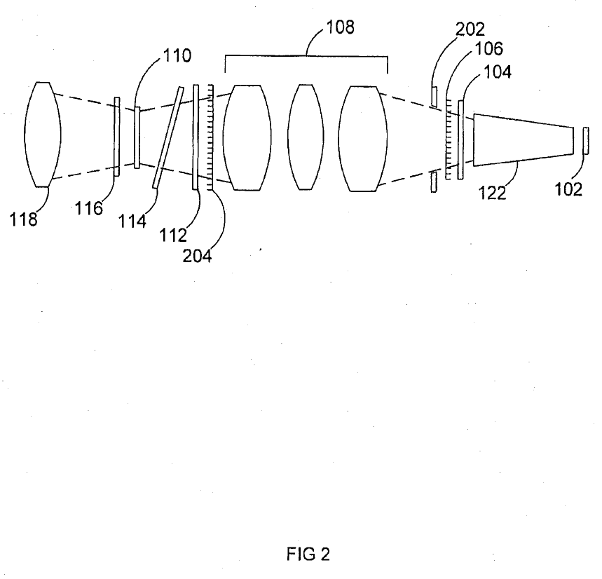

In alternative and/or overlapping embodiments generally disclosed by FIG. 2, a baffle 202 can be placed between the light polarizing system 120 and the relay optic assembly 108, and a number of other locations, to potentially further enhance contrast by reducing the amount of stray light that might interfere with the operation of the LCD 110. Also, in alternative and/or overlapping embodiments, a reflective linear polarizer 204 can be placed between the relay optic assembly 108 and the pre-polarizer 112 to further enhance contrast and reduce thermal concentration on subsequent components.

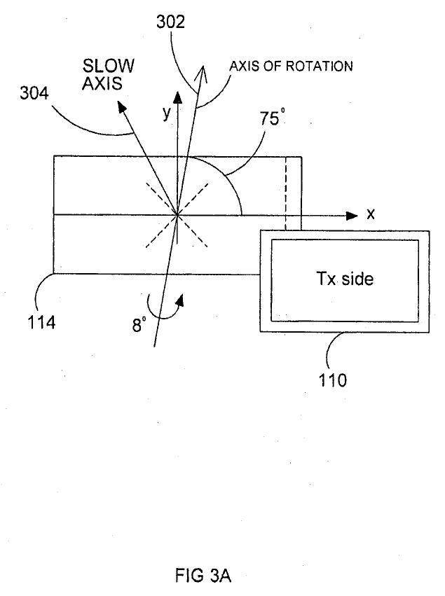

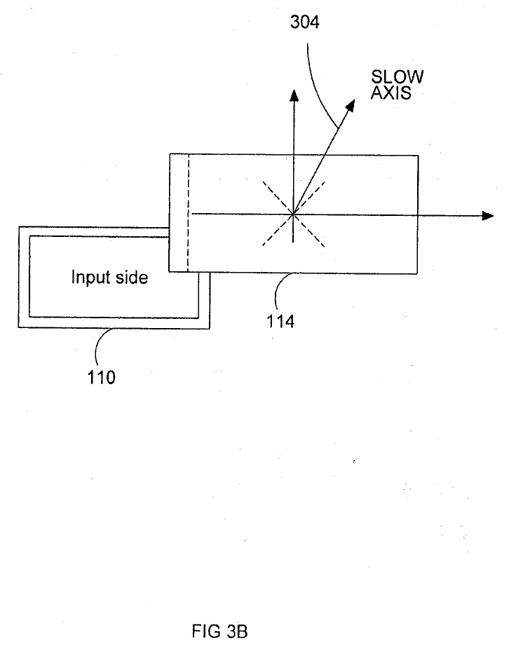

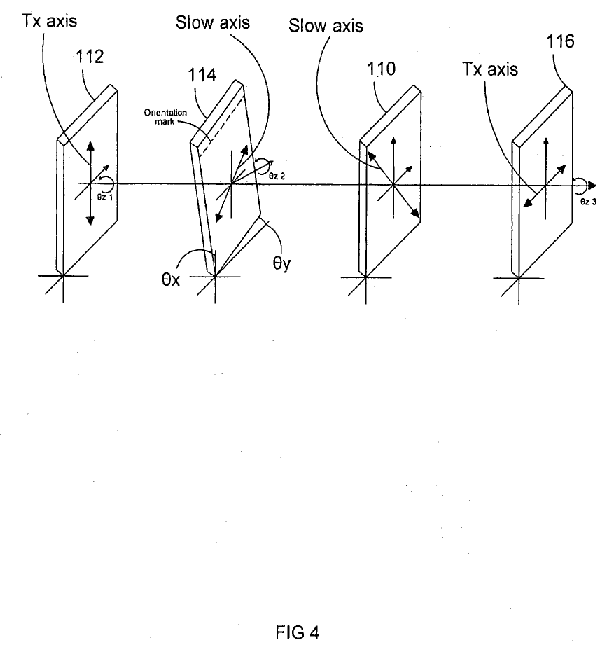

FIG. 3A is a view of the compensation plate 114 and LCD 110 from the perspective of facing toward the light source 102. Referring to FIG. 3A, this figure discloses an example compound angle orientation of the compensation plate 114 with respect to the LCD panel 110. One methodology for arriving at the example orientation is to first assume the axis of rotation 302 is placed through the center of the compensation plate 114 and is initially orthogonal to the plane of the compensation plate 114. The axis of rotation 302 is then tilted such that it is 75° off of the X axis as shown, and then rotated counter-clockwise 8°. This resultant orientation is (relative to LCD 110) appropriate to significantly improve contrast for use with the Epson TN90 LCD Panel mentioned above. Note that the resultant orientation of the compensation plate 114 has different θx, θy, and θz angular components from the orientation of the LCD 110, as shown and described further below with regard to FIG. 4.

FIG. 3B discloses the view of the components of FIG. 3A, but from the opposite side. FIGS. 3A and 3B both depict the slow axis 304 of the compensation plate 114.

The orientation of the various plates with respect to one another is now shown and discussed with regard to FIG. 4. Referring now to FIG. 4, the compensation plate 114 is both rotated and clocked about its three axes, as generally indicated previously. Specifically, the compensation plate 114 is oriented with different θx, θy, and θz components relative to the LCD 110. This combination of tilting and clocking (i.e., orienting differently with regard to θx, θy, and θz) allows the present subject matter to greatly improve contrast. This concept can be used with any number of LCD panels, as discussed further below.

In addition to orienting the compensation plate 114 differently from the LCD panel 110, one or more embodiments contemplate that the pre-polarizer 112 and/or the analyzer 116 can also be oriented at one or more different angles with respect to the LCD panel 110 to achieve improved contrast results. More specifically, one or more embodiments envision that the pre-polarizer 112 and analyzer 116 can be oriented along Oz (i.e., they are clocked somewhat with respect to the LCD panel 110). Clocking the plates (including the compensation plate 114) allows for, e.g., correction for slight manufacturing differences among LCDs of the same manufacturer and model.

In function, the compensation plate 114 can be thought of as a compound O plate. This is due largely to the compound angle (with respect to the LCD 110) at which the plate is held.

In general, the panels described above can change characteristics somewhat with temperature, and thus one or more embodiments contemplate maintaining the plate at a particular temperature, which can be obtained empirically, depending upon the particular type of components being used. In one or more embodiments, the components are held at 47° centigrade, plus or minus 1° centigrade. Also, in at least some embodiments, measurements could be taken at a range of illumination cones that we used for the compensated design, if it was a plus or minus 12° cone, and the nominal in-plane retardance values of the panels where 3, 2.4, and 2.6 for red, green, and blue wavelength centers.

With regard to the slow axis of the compensation plate 114, in at least some embodiments (e.g., where the Epson TN90 LCD panel is used) it is envisioned that the average slow axis values from characterization can be 28, 31, and 26° in B/G/R color channels, respectively.

One or more embodiments envision that the compensation plate 114 has a substrate (to give the plate its retardance properties) on one side, and it is envisioned that the substrate side be facing the LCD 110. It is further envisioned that an orientation mark be placed on the substrate side of the orientation plate 114, in part, to help ensure during assembly that the substrate side is facing the LCD 110.

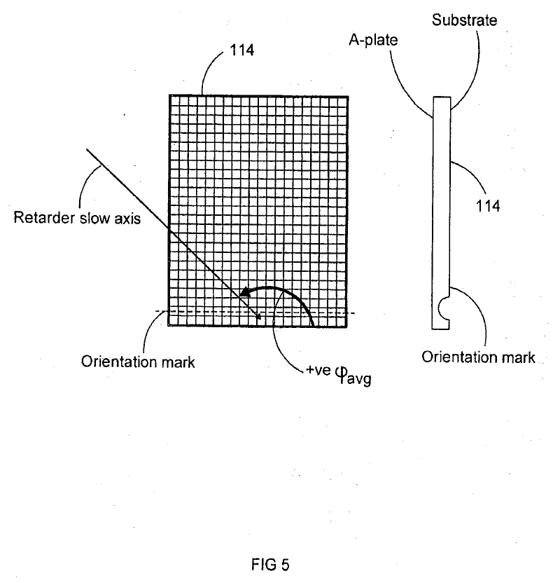

Though in one or more embodiments the compensation plate 114 effectively acts as a compound O plate (when positioned as mentioned), the plate itself (e.g., in uniform orientation with the LCD 110) has characteristics of an A plate. With regard to those characteristics, and in one or more embodiments, the average slow axis orientation, Φ_{avg} of the A-plate retardance is defined as the angle between the short side of the compensation plate 1 14 and the retarder slow axis. It is positive when measured from the short side of the compensation plate 114 in a counter-clockwise direction as indicated by FIG. 5. The slow-axis orientation is measured at normal incidence.

The ability to change the orientation of the compensation plate 114, pre-polarizer 112, and analyzer 116 all with respect to the orientation of the LCD panel 110 allows for optimization of contrast with regard to any number of different types and brands of LCD panels.

Regarding the “substrate” on compensation plate 114, one or more embodiments contemplate that the substrate is made of an organic material (e.g., one or more polymers). As is known in the art, organic materials have various advantages, and while organic materials break down more readily when exposed to high amounts of ultraviolet light, it is envisioned in one or more embodiments that the light source used is an LED light source. Such light sources emit lower amounts of ultraviolet radiation than other conventional light sources.

Where a compensation plate 114 exists that has taken the retardance/leakage characteristics of a given LCD 110 into account, to then determine an appropriate set of tiling and clocking angles (i.e., θx, θy, and θz) to enhance contrast, one or more embodiments contemplate that the LCD 110 is first set to all pixels “on,” and the light transmission value through the LCD (and analyzer) is measured. Then, all pixels in the LCD panel are set to “off,” and again the light transmission is measured. This process is repeated with the compensation plate 114 being slightly adjusted each time at one or more of various angles, θx, θy, and θz, until an acceptable result is achieved (e.g., when all pixels are set to “off,” a minimal amount of light leaks through the analyzer). In general, various embodiments contemplate that this technique can be done manually, or in an automated manner (i.e., a machine can be used to finely adjust the angles of the plates and test for light leakage until a satisfactory result is obtained). As indicated above, in one or more embodiments, the pre-polarizer 112 and/or analyzer 116 can also be adjusted, particularly through angle Oz, to achieve overall enhanced contrast results.

In one or more embodiments, one technique for initially obtaining a compensation plate 114 for a given LCD 110 is to direct light through the LCD at a variety of angles, with the LCD 110 turned full on (i.e., completely transmissive) to obtain Stokes coefficients and determine the retardance (i.e., shifting of phase) that occurs at the various angles. With that information, a polar plot (matrix) can be constructed, and a compensation plate 114 could be made with a coating having appropriate retardance to compensate for (i.e., undo) the retardance that occurs at each of the various angles in the LCD 110.

One skilled in the art will appreciate the various retardance properties of various coatings, and how the retardance properties change with, e.g., thickness. Consequently, the thickness of the coatings and the angles that the light is directed thereon can ultimately determine the retardance properties at those angles.

In one or more embodiments, a polarimeter can be used to check the retardance level of the LCD at various angles of light, and thus assess the type and thickness of coating(s) to use on the compensation plate 114 in order to compensate for unwanted effects that affect contrast in the LCD 110. Polarimeters can be obtained from Axometrics of Huntsville, Ala.

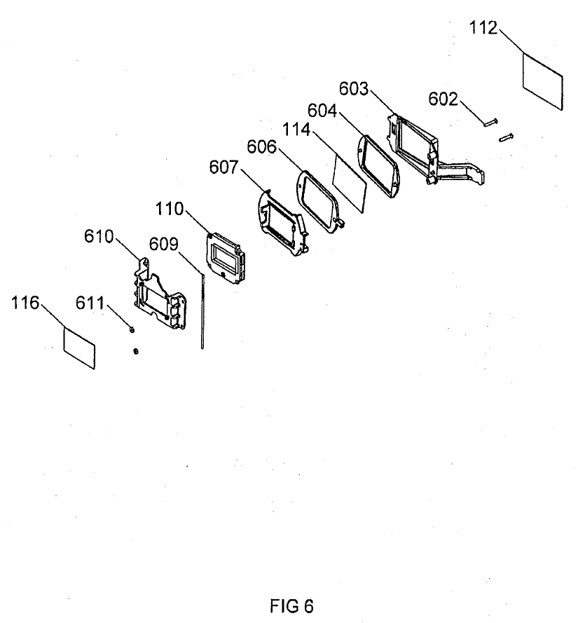

Components as assembled in a particular working structure of one or more embodiments are now described with regard to FIG. 6. Referring to FIG. 6, the LCD 110 is held in place by LCD holder sections 610 and 607. In one or more embodiments, it is envisioned that these LCD holders 610 and 607 can be used to adjust the LCD 110 to ascertain “retardance” at various angles with regard to a light source, as indicated above in conjunction with usage of a polarimeter.

The compensation plate 114 is held in place by compensation plate holders 606 and 604. Using compensation plate holder 606, and the small handle protruding therefrom, various embodiments contemplate that angle θz can be adjusted, as discussed above, to achieve better contrast. This assumes a situation where angles θx, θy have already been calculated for the LCD 110, and thus θx, θy are set in place by the compensation plate holder 606. However, where θx, θy have not yet been calculated, various embodiments envision that all of the various angles θx, θy, and θz can be adjusted to achieve better contrast.

In general, in determining appropriate values for θx, θy, and/or θz for purposes of enhancing contrast, one or more embodiments envision that the determination can be accomplished by manually moving and testing the compensation plate 114 through one or more of the various angles, or by use of a computer simulation. If performed manually, various embodiments envision use of a mount such as part number c58-861 from Edmund Optics of Barrington, N.J. Regarding use of a computer simulation, for example, if data is available regarding how a compensation plate 114 with a particular type of coating and LCD 110 responds to light at certain angles, one or more embodiments envision that the computer simulation can use the data to determine the appropriate angles at which to orient the compensation plate 114 with respect to the LCD 110.

Component holder 603, in conjunction with screws 602 and bolts 611, hold the aforementioned components in place together. The analyzer 116 and pre-polarizer 112 are also shown in the relative positions that they would be expected to reside. A thermistor 609 or thermocouple for measuring temperature could also be used for closed loop control of the LCD temperature.

In one or more embodiments, the holders 604 and 606 of, for example, the compensation plate 114, can be made of a low coefficient of thermal expansion (CTE) plastic material, such as E2 from Cool Polymers of Warwick, R.I. Low CTE reduces stress and mechanical tolerance, that can alter holding angles and introduce stress birefringence, both of which reduce polarization purity.

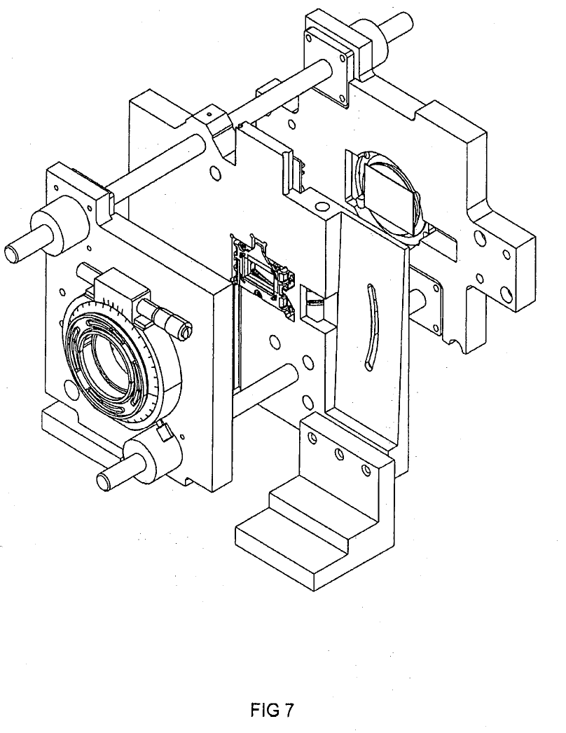

FIG. 7 depicts an example implementation of an alignment fixture of a complete device having the components described above with regards to FIG. 6, as envisioned by one or more embodiments. Guide holes and rotational stages in the fixture are used to adjust the components to their proper position using, e.g., light cured glue. Once the components therein are positioned at the appropriate contrast-enhancing compound angle as described above, the components are locked mechanically using, e.g. light cured glue. The completed assembly of FIG. 6, which was aligned by the example implementation of the apparatus in FIG. 7, is placed into a projector, for example.

The above detailed description is intended to be illustrative, and not restrictive. The scope of the invention should, therefore, be determined with reference to the appended claims, along with the full scope of equivalents to which such claims are legally entitled.

What is claimed is:

1. A system, comprising:
an analyzer;
a Liquid Crystal Display (LCD) to allow, limit or block passage of polarized light as a projected image to the analyzer, wherein the LCD includes a plurality of crystals that provide the LCD with a plurality of pixels, wherein the crystals in the LCD have non-ideal polarization states resulting from receipt and retardance of non-collimated incident angles of light, and wherein the non-ideal polarization states introduce unwanted phase shifts of the light in the projected image; and
a compensation plate configured to introduce desired phase shifts to compensate for the unwanted phase shifts of the light introduced by non-ideal polarization states introduced by the LCD.

2. The system of claim 1, wherein the compensation plate is positioned at a compound angle relative to the position of the LCD.

3. The system of claim 1, wherein the compensation plate includes a thermocouple.

4. The system of claim 3, further comprising a closed-loop temperature control system to control a temperature of the compensation plate using thermocouple.

5. The system of claim 1, wherein the compensation plate includes an organic substrate.

6. The system of claim 5, wherein the means for providing a polarized light includes a light emitting diode (LED) light source.

7. The system of claim 5, wherein the organic substrate includes one or more polymers.

8. The system of claim 1, wherein the compensation plate has a coating to provide appropriate retardance for various angles of incident light to compensate for retardance that occurs in the LCD for those angles of incident light.

9. The system of claim 1, wherein the means for providing a polarized light includes a light polarizing system with a solid state light source, further comprising:
a relay optics assembly positioned to transfer polarized light from the light polarizing system toward the LCD, wherein the relay optics assembly is configured to conserve system entendue.

10. The system of claim 9, further comprising a pre-polarizer positioned in a light transmission path between the relay optics assembly and the LCD.

11. The system of claim 10, further comprising a reflective linear polarizer placed between the relay optics assembly and the pre-polarizer.

12. The system of claim 9, further comprising a projection assembly, wherein the analyzer is positioned in a light transmission path between the LCD and the projection assembly.

13. The system of claim 9, further comprising a baffle positioned between the light polarizing system and the relay optics assembly.

14. A method, comprising:
setting all pixels in a liquid crystal display (LCD) “on”;
measuring light transmission when all pixels are set “on”;
setting all pixels in LCD “off”;
measuring light transmission when all pixels are set “off”;
if the measured light transmissions are not acceptable, adjusting a compound angle of a compensation plate with respect to the LCD, and re-measuring light transmission when all pixels are set “on” and when all pixels are set “off”.

15. The method of claim 14, wherein adjusting includes manually adjusting the compound angle.

16. The method of claim 14, wherein adjusting includes automatically adjusting the compound angle until the light transmissions are acceptable.

17. The method of claim 14, further comprising adjusting at least one angle of a pre-polarizer with respect to the LCD.

18. The method of claim 14, further comprising adjusting at least one angle of an analyzer with respect to the LCD.

19. A method, comprising:
turning a liquid crystal display (LCD) “full on” to be transmissive;
directing light through the full on LCD at a plurality of angles;
determining retardance for the LCD for the plurality of angles;
constructing a polar plot to represent the retardance for the plurality of angles; and
using the polar plot to provide an appropriate coating for a compensate plate to compensate for the retardance of the LCD.

20. The method of claim 19, wherein determining retardance includes using a polarimeter.
